(19) United States
(12) Patent Application Publication
(10) Pub. No.: US 2026/0217072 A1
(43) Pub. Date: Jul. 30, 2026

(54) HINGE LOCKING DEVICES AND METHODS

(71) Applicants: Derrick Legros, Thunder Bay (CA); Paul Legros, JR., Thunder Bay (CA)

(72) Inventors: Derrick Legros, Thunder Bay (CA); Paul Legros, JR., Thunder Bay (CA)

(21) Appl. No.: 19/259,753

(22) Filed: Jul. 3, 2025

(30) Foreign Application Priority Data
Jan. 29, 2025 (CA) 3263572

(51) Int. Cl. B60D 1/24

(52) U.S. Cl. CPC B60D 1/24

(57) ABSTRACT

A device for locking hinges which join a pair of vehicular elements together said device including a first and second portion for attachment to vehicular elements including apertures, a limiter, an actuator and a pin, wherein the pin upon insertion through the apertures links and pivotally connects the first and second portion is disclosed.

### BACKGROUND

This patent application relates to hinges, particularly to devices and methods of locking hinges, and more particularly to devices and methods of locking hinges which join a pair of vehicular elements together.

It is known to link or join one vehicular element to another vehicular element in order to provide at least a pair of vehicular elements (a set of vehicular elements). Such sets of vehicular elements are known in different designs and in different forms of adaptation for different uses. Whilst the majority of these are land based uses the designs and adaptations do not preclude their use for vehicular elements on water, in air or within or upon another medium.

The set of vehicular elements may be joined via a hinge such that actions of turning (either going forward or in reverse) can be accomplished with a smaller turning circle (i.e. radius of turning) than if the set of vehicular elements were not hinged but connected in a manner that did not allow relative motion of the vehicular elements relative to one another. However, there are instances during use of these sets of vehicular elements where it would be beneficial to lock the hinge such that further relative motion of the vehicular elements relative to one another is prevented or limited in range and/or direction.

Whilst designs within the prior art have been presented that limit either the maximum relative motion of the vehicular elements relative to one another or the rate of relative motion of the vehicular elements relative to one another (i.e. damping the motion) these designs are complex and accordingly expensive to deploy initially and to subsequently maintain. Further, these designs do not address many circumstances where temporality locking elements together is beneficial.

Accordingly, it would be beneficial to provide manufacturers and operators of sets of vehicular elements with a low complexity, low cost and low maintenance system for temporality locking a hinge which joins a pair of vehicular elements.

Other aspects and features of the present invention will become apparent to those ordinarily skilled in the art upon review of the following description of specific embodiments of the invention in conjunction with the accompanying figures.

### SUMMARY

It is an object of the present invention to mitigate limitations within the prior art relating to hinges, particularly to devices and methods of locking hinges, and more particularly to devices and methods of locking hinges which join a pair of vehicular elements together. In accordance with an embodiment of the invention there is provided a device comprising:
a first portion for attachment to a first vehicular element comprising a first aperture;
a second portion for attachment to a second vehicular element comprising a second aperture;
a limiter forming part of the first portion; an actuator coupled to the limiter and the first portion;
and a pin; wherein the pin upon insertion through the first aperture and the second aperture links and pivotally connects the first portion to the second portion.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a side view of a tractor (front section) and the trailer (rear section) traveling on an uneven road where the front and rear sections are pivoted and hinged;

FIG. 2 depicts an exploded perspective view showing, in cut-away, a pivotal connection between front and rear bed sections which provides for both up and down pivotal interconnection and rotational interconnection between the front and rear sections;

FIG. 3 depicts an exploded perspective view showing, in cut-away, a pivotal connection between the front and rear bed sections which provides for rotational interconnection between the front and rear bed sections;

FIG. 4 depicts exploded perspective views showing, in cut-away, a pivotal connection between the front and rear bed sections which provides for up and down pivotal interconnection and rotational interconnection between the front and rear bed sections with adjustable range of motion - locking system for the up and down pivotal interconnection; and

FIGS. 5 and 6 depict images of a pivotal connection between the front and rear bed sections which provides for up and down pivotal interconnection and rotational interconnection between the front and rear bed sections with adjustable range of motion - locking system for the rotational pivotal interconnection.

### DETAILED DESCRIPTION

The present invention is directed to hinges, particularly to devices and methods of locking hinges, and more particularly to devices and methods of locking hinges which join a pair of vehicular elements together.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “fitting” as used herein and throughout this disclosure, refers to any machine component, piping or tubing part that can attach or connect two or more parts. Such fittings may include, but not be limited to, a coupling, couplings, compression fitting, pipe fitting, piping fittings, plumbing fittings, and plumbing fitting.

A “mounting” as used herein and throughout this disclosure, refers to part of a device, system., ancillary, etc. which is configured to support and/or attach another device, system, ancillary, components etc. to said part of the device, system, ancillary, component etc. A mounting typically supports demountable attachment of the parts but may be employed in permanent attachment to define the location of the point of attachment or support demountable attachment prior to permanent attachment.

A “fixing” or “attachment means” as used herein and throughout this disclosure, refers to component, device, or means employed to permanently or demountably attach a device, system, ancillary, components etc. to part of another device, system, ancillary, component etc. This may include, but not be limited to, depending upon whether permanent or demountable and the material(s) being joined fasteners, glues, resins, epoxies, cementing, welding, soldering, brazing, pressure differentials, magnets, clamps, clips, ties, supports, physical retention elements such as clips and crimps, and physical retention methods such as friction and interference fit. Fasteners may include, but not be limited to, bolts, nuts, washers, screws, threaded fasteners, rivets, nails, pins, hook-and-eye, and hook and loop.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

It is known to link or join one vehicular element to another vehicular element in order to provide at least a pair of vehicular elements (a set of vehicular elements). Such sets of vehicular elements are known in different designs and in different forms of adaptation for different uses. Whilst the majority of these are land based uses the designs and adaptations do not preclude their use for vehicular elements on water, in air or within or upon another medium.

Exemplary land based sets of vehicular elements may include, but not be limited to, a vehicle with a trailer, e.g. a car with a trailer; a vehicle with a caravan such as a car with caravan; a vehicle towing another vehicle, e.g. a transportation vehicle (commonly referred to as a truck or tractor unit) towing a car; a tractor using towing a trailer (commonly referred to as tractor-trailer units); etc. In some instances a trailer may tow a trailer which itself is towing another trailer or variants thereof where three or more vehicular elements may be linked.

The set of vehicular elements may be joined via a hinge such that actions of turning (either going forward or in reverse) can be accomplished with a smaller turning circle (i.e. radius of turning) than if the set of vehicular elements were not hinged but connected in a manner that did not allow relative motion of the vehicular elements relative to one another. However, there are instances during use of these sets of vehicular elements where it would be beneficial to lock the hinge such that further relative motion of the vehicular elements relative to one another is prevented or limited in range and/or direction.

Whilst designs within the prior art have been presented that limit either the maximum relative motion of the vehicular elements relative to one another or the rate of relative motion of the vehicular elements relative to one another (i.e. damping the motion) these designs are complex and accordingly expensive to deploy initially and to subsequently maintain. Further, these designs do not address many circumstances where temporality locking elements together is beneficial.

Accordingly, it would be beneficial to provide manufacturers and operators of sets of vehicular elements with a low complexity, low cost and low maintenance system for temporality locking a hinge which joins a pair of vehicular elements.

Embodiments of the invention may be employed with a hinge which is non-demountable such that the pair of vehicular elements are linked permanently to one another. Within other scenarios embodiments of the invention may be employed with a hinge which is demountable such that the pair of vehicular elements are not linked permanently to one another wherein the pair of vehicular elements may be joined-separated as required or a vehicular element of the pair of vehicular elements can be joined-separated to different vehicular elements, such as a different trailer to a tractor unit for example.

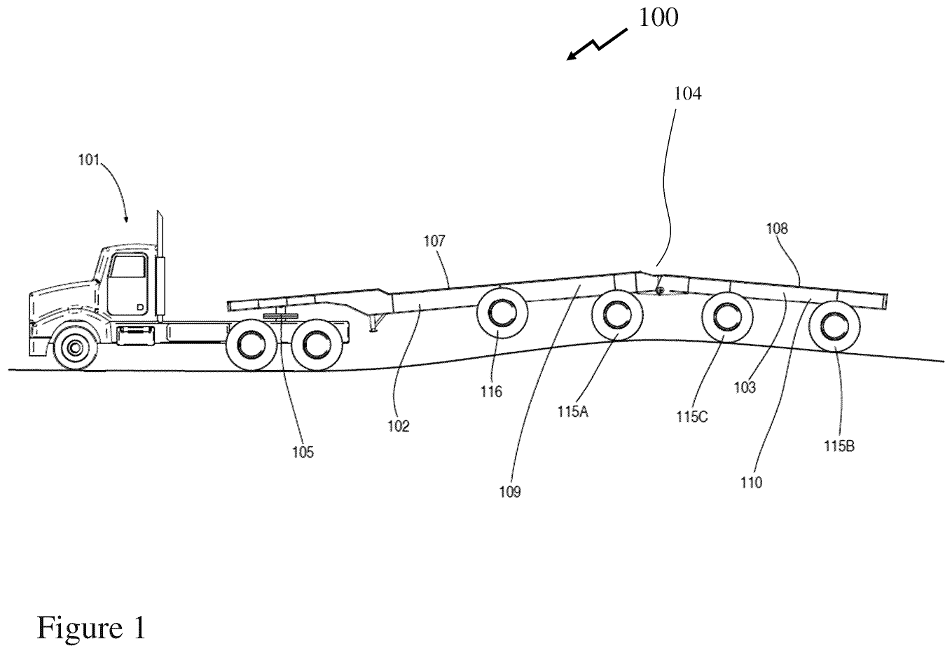

FIG. 1 is a Side View 100 of a Front Bed Section 102 (front section) and Rear Bed Section 103 (rear section) traveling on an uneven road where the Front Bed Section 102 and Rear Bed Section 103 are pivoted and hinged with respect to one another. Whilst the following description is presented with respect to a hinged connection between a Front Bed Section 102 and a Rear Bed Section 103 the embodiments of the invention may be applied generally to a first vehicular element of a set of vehicular elements and a second vehicular element of the set of vehicular elements. The Front Bed Section 102 and the Rear Bed Section 103 being connected to a Tractor 101 via a connector, what is known in the industry as a Fifth Wheel 105.

As illustrated, the Front and Rear Bed Sections 102 and 103 respectively are carried upon laterally spaced apart first to third Wheel Assemblies 115A, 115B, and 115C which may, for example, include one or more sets of Air-Lift Wheel assemblies as is also well known in the art, with an Air-Lift Assembly 116 being shown in its retracted position. The optimum number of air-lift wheel assemblies 116 may, for example, be related to the length of the trailer comprising the Front and Rear Bed Sections 102 and 103 respectively and the expected load to be carried. Each Air-Lift Wheel assembly 116, when lowered, contributes to the distribution of the load, and when lifted, contributes to the ability of the trailer to better turn around curves and corners, and to extend the lifespan of the air-lift tires.

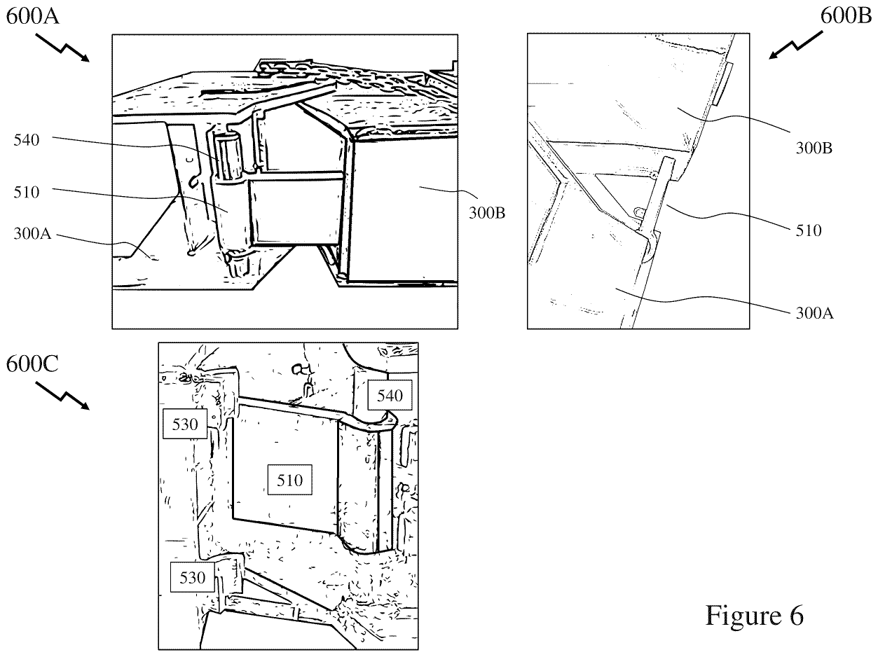

The Front and Rear Bed Sections 102 and 103 respectively are pivotally connected to one another about a Joint 104 which as described and depicted below with respect to FIG. 6 provides for pivoting motion of the Rear Bed Section 103 with respect to the Front Bed Section 102. As depicted in FIG. 1 the Joint 104 allows for the assembled vehicular assembly to travel over a bump whereby the Front and Rear Bed Sections 102 and 103 can pivot downwardly relative to one another. This pivoting action between the two bed sections reduces the stress on the trailer by reducing what is known as “long-arm elevation” which occurs with ridged (non-pivoting) trailer beds. The term “long-arm elevation” is used to describe an environment where a ridged trailer bed acts in combination with a bump as a lever-the bump being the fulcrum point-with one end of the trailer bed lifted (air-born). By pivoting the front and rear bed sections together about a horizontal axis within the Joint 104, the long arm elevation effect is reduced. For example, whilst backing the trailer into a ditch for loading or for any other reason such as going over a bump, the Rear Bed Section 103 pivots downwardly. At the bottom of a dip in the surface the trailer is moving across, for example, the Rear Bed Section 103 pivots upwardly. In turning, either going forward or in reverse, the Front Bed Section 102 and the Rear Bed Section 103 pivot about a vertical axis of the Joint 104.

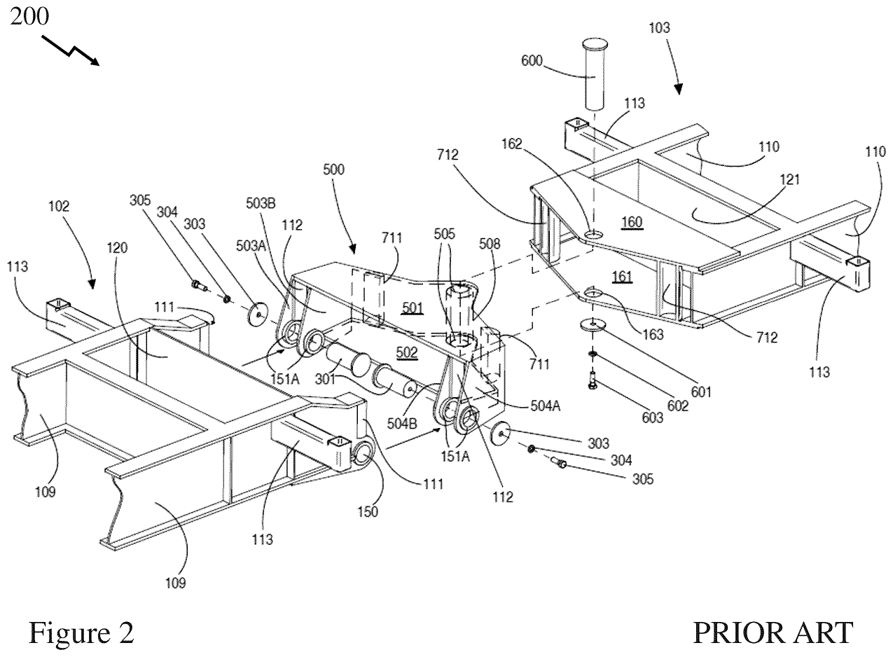

Now referring to FIG. 2 there is depicted an exploded perspective View 200 showing, in cut-away, a design of the Joint 104 forming part of a Front Bed Section 102 and Rear Bed Section 103 thereby providing a pivotal connection between the front and rear sections which provides for both up and down pivotal interconnection (about a horizontal axis of the Joint 104) and rotational interconnection between the front and rear sections (about a vertical axis of the Joint 104) of a set of vehicular elements. FIG. 2 being according to the prior art as described within Canadian2,566,451 “Vehicle Trailer.”

As depicted in FIG. 2 the Front Bed Section 102 includes two spaced apart and longitudinally extending Front Frame Members 109, which are respectively in-line with two spaced apart and longitudinally extending rear frame members 110 of the Rear Bed Section 103. The Front Frame Members 109 are interconnected by an appropriate number of Front transverse or Cross Members 120 and, similarly, the Rear Frame Members 110 are likewise interconnected by an appropriate number of Rear Cross Members 121. The front and rear bed sections 102, 103, can either be left uncovered as an open framework which is commonplace when transporting some loads or covered with front and rear platforms 107, 108 if desired as illustrated in FIG. 1. Alternatively, one or both of the Front and Rear Bed Sections 102 and 103 may be a partially or fully enclosed structure (e.g. container).

The rear of Front Frame Members 109 are pivotally interconnected in-line to the rear frame members 110 by axially aligned pivot Pins 301. These Pins 301 may be positioned proximate the bottoms of opposing Front and Rear Frame Members 109 and 110 respectively in order to reduce the pulling power required by Tractor 101. Pins 301 at one end have an enlarged Head 302 with their shanks extending through Apertures 150 and 151 respectively positioned on the opposed lower ends of in-line front and rear longitudinal members 109 and 110. Accordingly, when the Front and Rear Bed Sections 102 and 103 are pivotally connected one to the other, the Pins 301 are secured in position by means of End Washers 303, Lock Washers 304 and Securing Bolt 305.

Within the design depicted in FIG. 2 a vertical motion limit means is provided which includes first Abutment Means 111 located proximate the rear of each of the two longitudinally extending Front Frame Members 109. Complementary second Abutment Means 112 are located proximate the front of the two in-line rear frame members 110. The first and second Abutment Means 111,112 abut one another when the Front and Rear Bed Sections 102,103 are in substantially parallel planes to prevent further upward pivoting. The first and second Abutment Means 111,112 are secured to their respective frame members by Reinforcing Webs 501,502.

The Front Bed Section 102 as illustrated in FIG. 2 has had the overlying Platform 107 removed whilst Rear Bed Section 103 has had the overlay Platform 106 removed. The forward or leading end of Rear Bed Section 103 is provided with spaced apart upper and lower triangular-shaped Cheek Plates 160 and 161 which are connected to the two elongate Frame Members 110. Upper and Lower Cheek Plates 160 and 161 each respectively include In-Line Apertures 162 and 163 which are located along the center line of and perpendicular to the longitudinal axis of the Rear Bed Section 103.

Disposed between the Front and Rear Bed Sections 102 and 103 is Connector Link 500 which is generally triangular in shape and which includes upper and lower Cheek Plates 160 and 161 and spaced apart Sidewall Pairs 503A, 503B and 504A and 504B as illustrated. Sidewalls 503A and 503B are each provided with Lateral Apertures 151A which are axially aligned with Lateral Frame Apertures 150 provided in sidewalls 504A and 504B with a C-shaped elongate channel member 112A being located within each pair of sidewalls. Each Pin 301 extends through the Lateral Apertures 151A and axially aligned Lateral Frame Aperture 150 on one side before being secured in position by means of End Washers 303, Lock Washers 304 and Securing Bolt 305.

At the trailing end of Connector Link 500, Vertical In-Line Apertures 505 are provided in the spaced apart upper and lower Cheek Plates 501 and 502. Connector plate 500, as a unit, is insertable interior of upper and lower Cheek Plates 160 and 161 of Rear Bed Section 103 such that Apertures 162 and 163 are aligned with upper and lower Vertical Apertures 505 of Connector Link 500. As illustrated, Pivot Pin 600, in order to adjoin Connector Link 500 to Rear Bed Section 103 is inserted through Aperture 162 in the upper Cheek Plate 160 and then through both Apertures 505 in Connector Link 500 and Aperture 163 in lower Cheek Plate 161. The Pivot Pin 600 is secured in position via Washer 601, Pivot Lock Washer 602 and Fastening Bolt 603.

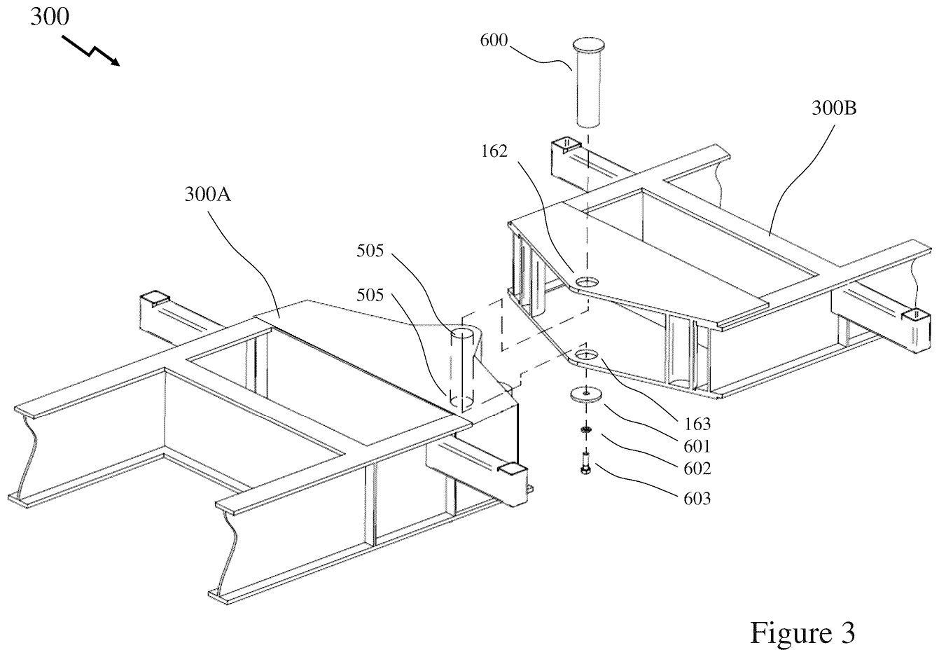

Because Rear Bed Section 103 is pivotally connected to Connector Link 500 about Pivot Pin 600, relative to Connector Link 500, Rear Bed Section 103 is permitted to swing laterally. In other words, Connector Link 500 and the Rear Bed Section 103 remain in the same plane, whilst being permitted to pivot relative one to the other about Pivot Pin 600. On the other hand, the forward end of Connector Link 500 is connected to forward bed section in a manner identical to the pivotal connection of rear bed section 103 to Front Bed Section 102 discussed in connection with FIG. 3. As a result, Rear Bed Section 103 together with Connector Link 500, relative to Front Bed Section 102, are permitted to move downwardly with any upward movement beyond the two bed sections lying in a substantially horizontal plane, being restricted by virtue of Abutments 111 on Front Section 102 engaging C-shaped abutments 112 on Connector Link 500. Swinging movement between Rear Bed Section 103 and Front Bed Section 102 is achieved as a result of Rear Bed Section 103 pivoting about Pivot Pin 600 which is physically connected to Connector Link 500 as described above.

In order to restrict the degree of lateral swing between the Front and Rear Bed Sections 102 and 103 a stop means in the form of two laterally spaced apart C-shaped Members 712 are located on and extend between Cheek Plates 160 and 161 on Rear Bed Section 103, and two laterally spaced apart Cylindrically Shaped Members 711 are located on and extending between Cheek Plates 501 and 502 of Connector Link 500. The maximum extent of pivotal (swing) action of Connector Link 500 relative to Rear Bed Section 103 about Pivot Pin 600 is limited or arrested when Cylindrically Shaped Members 711 receivingly engages in abutting relationship C-shaped Member 712.

Within an embodiment of the invention the orientation of the Connector Link 500 disposed between the Front and Rear Bed Sections 102 and 103 can, if desired, be reversed and achieve the same functional result regarding the vertical and rotational movement.

Referring to FIG. 3 there is depicted a variant of the design depicted in FIG. 2 wherein the design provides for only rotational motion about a vertical axis wherein a Front Bed Section 300A is attached to Rear Bed Section 300B via Vertical In-Line Apertures 505 within the Front Bed Section 300A and In-Line Apertures 162 and 163 which are located along the center line of and perpendicular to the longitudinal axis of the Rear Bed Section 300B using Pivot Pin 600, in which is secured in position via Washer 601, Pivot Lock Washer 602 and Fastening Bolt 603. Accordingly, the Front and Rear Bed Sections 300A and 300B pivot about this vertical axis without any ability for the Front and Rear Bed Sections 300A and 300B to pivot about a horizontal axis as depicted in FIG. 2. This single axis of relative motion may be applicable to some sets of vehicular elements whilst the dual axis of relative motion of FIG. 2 may be applicable to other sets of vehicular elements some of which may overlap the sets of vehicular elements.

As noted in respect of FIG. 2 vertical motion of the Front and Rear Bed Sections 102 and 103 about the horizontal axis is provided by first Abutment Means 111, located proximate the rear of each of the two longitudinally extending Front Frame Members 109 of the Front Bed Section 102, engaging second Abutment Means 112, are located proximate the front of the two in-line rear frame members 110 of Rear Bed Section 103. These second Abutment Means 112 being between the spaced apart Sidewall Pairs 503A, 503B and 504A and 504B. The range of vertical motion being defined by the positions of the abutting faces of the first Abutment Means 111 and second Abutment Means 112 relative to the rotational axis.

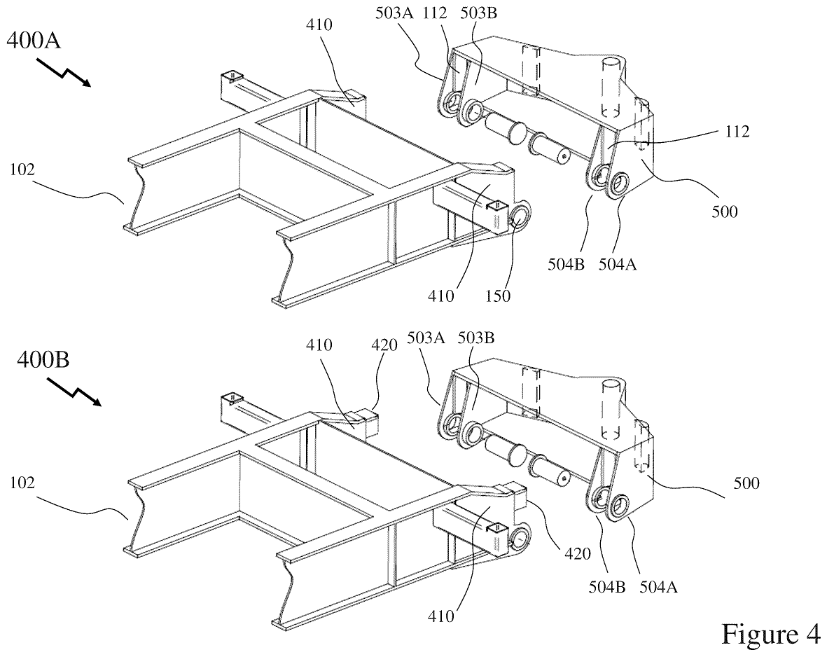

However, it would be beneficial to provide the operator of a set of vehicular elements using the configuration depicted in FIG. 2 with an ability to have some control over the relative vertical motion of the Front and Rear Bed Sections 102 and 103. Accordingly, referring to FIG. 4 there is depicted in first and second Views 400A and 400B a dynamic abutment means between the Front Bed Section 102 and the Connector Link 500. In first View 400A the Connector Link 500 is depicted with Front Bed Section 102 where Frame Ends 410, of a pair of spaced apart and longitudinally extending frame members, such as Front Frame Members 109 and 110 in FIG. 2, face the second Abutment Means 112 of the Connector Link 500 which are disposed between the spaced apart Sidewall Pairs 503A, 503B and 504A and 504B. It would be evident that the Frame Ends 410 are disposed further away from the second Abutment Means 112 than the first Abutment Means 111 in FIG. 2 such that increased vertical motion is possible relative to the design of FIG. 2.

However, as depicted in second View 400B in FIG. 4 Extendable Abutment Means 420 are depicted extending out of the Frame Ends 410 such that they are closer to the second Abutment Means 112 wherein the vertical range of motion of Connector Link 500 relative to the Front Bed Section 102, and therein the Rear Bed Section to which the Connector Link 500 is attached is decreased. The further the Extendable Abutment Means 420 project the lower the range of vertical motion which can be, in some variants of the design, be reduced to zero. Each of the Extendable Abutment Means 420 is connected to a Deployment Means, which is not depicted for clarity in FIG. 4, wherein under the action of the operator or a control system the Deployment Means extends or retracts the Extendable Abutment Means 420 to one or more of lock the sections relative vertical motion, limit the sections relative vertical motion or remove the limitation to the relative vertical motion of the sections.

Within an embodiment of the invention the Deployment Means may have two positions, off and on, such that the Extendable Abutment Means 420 is either retracted fully allowing full range of motion or extended fully to limit motion to a reduced range or completely.

Within an embodiment of the invention the Deployment Means may have multiple set positions or be continuously set such that the Extendable Abutment Means 420 can be set to different defined ranges of motion between retracted fully allowing full range of motion or fully extended to limit motion to a reduced range or no motion.

Within an embodiment of the invention the Extendable Abutment Means 420 and associated Deployment Means may be employed in conjunction with the design depicted in FIG. 2 such that the vertical range of motion may be reduced or eliminated under the action of an operator and/or control system.

Within an embodiment of the invention the Deployment Means may be a hydraulically driven mechanical actuator where the hydraulic system pressure or fluid volume adjust the stroke of the actuator and therein the position of the Extendable Abutment Means 420.

Within an embodiment of the invention the Deployment Means may be a fluidically driven mechanical actuator where the fluid system pressure or volume adjust the stroke of the actuator and therein the position of the Extendable Abutment Means 420.

Within an embodiment of the invention the Deployment Means may be an air operated brake where the air pressure or volume adjust the stroke of the actuator and therein the position of the Extendable Abutment Means 420.

Within an embodiment of the invention the Deployment Means may be an air operated brake chamber (also known as a service brake chamber) directly or indirectly connected to the air brake system of a vehicular element in the set of vehicular elements such that the Extendable Abutment Means 420 are extended upon actuation of the vehicles brakes. A Retraction Means may act to retract the Extendable Abutment Means 420 in conjunction with the air operated brake chamber such as a spring for example.

Within an embodiment of the invention the Deployment Means may be an air operated brake chamber (also known as a service brake chamber) indirectly connected to the air brake system of a vehicular element in the set of vehicular elements such that the Extendable Abutment Means 420 are extended upon actuation where the air pressure is provided from a second reservoir of the brake system where the first reservoir is employed by the vehicles brakes. A Retraction Means may act to retract the Extendable Abutment Means 420 in conjunction with the air operated brake chamber such as a spring for example.

Within an embodiment of the invention the Extendable Abutment Means 420 may be at maximum extension towards the Connector 500 such that the Deployment Means moves the Extendable Abutment Means 420 to increase the distance between it and the Connector 500.

Within an embodiment of the invention the Extendable Abutment Means 420 may be at minimum extension towards the Connector 500 such that the Deployment Means moves the Extendable Abutment Means 420 to decrease the distance between it and the Connector 500.

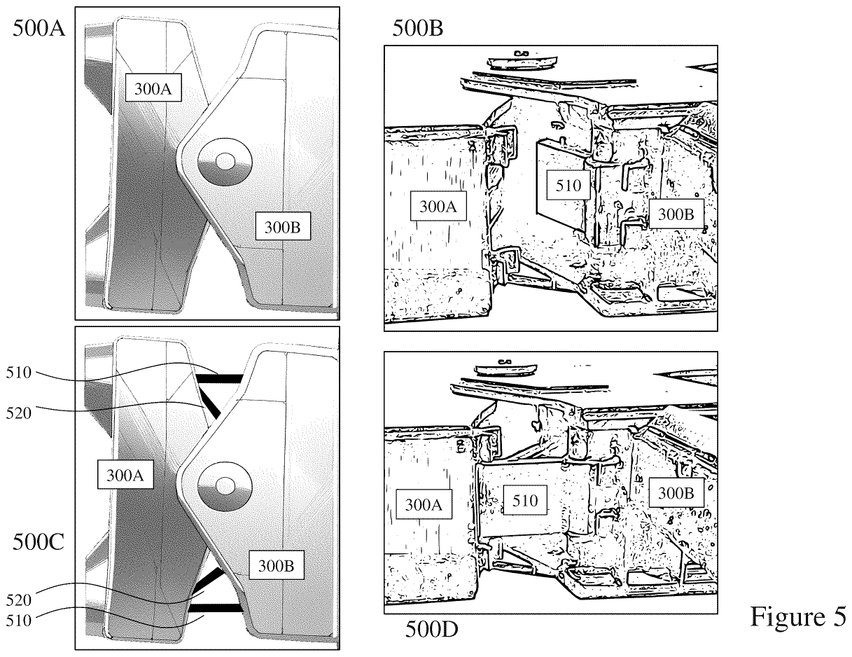

Referring to FIGS. 5 and 6 there are depicted images of a pivotal connection between the front and rear bed sections which provides for up and down pivotal interconnection and rotational interconnection between the front and rear bed sections with adjustable range of motion - locking system for the rotational pivotal interconnection.

As described and depicted within FIG. 4 an adjustable range of motion—locking system for an up down interconnection between a pair of vehicular element was presented. Accordingly, under action of the operator and/or a control system the range of motion about a horizontal axis of the interconnection between the pair of vehicular elements may be limited or eliminated (i.e. the interconnection is locked in this rotational axis). The configuration depicted in FIGS. 5 and 6 and variants thereof provides for an adjustable range of motion or locking of the rotational interconnection between a pair of vehicular elements. Accordingly, under action of the operator and/or a control system the range of motion about a horizontal axis of the interconnection between the pair of vehicular elements may be limited or eliminated (i.e. the interconnection is locked in this rotational axis).

Referring to first and second Images 500A and 500B in FIG. 5 a Rotational Connector Limiter according to an embodiment of the invention is depicted without the Rotational Limiting Elements being deployed such that rotational motion of the Front Bed Section 300A relative to the Rear Bed Section 300B is limited by the static Rotational Limiters. These may comprise, for example, Cylindrically Shaped Members 711 and laterally spaced apart C-shaped Members 712 as depicted in FIG. 2 or as depicted in third Image 600C in FIG. 6 a vertically spaced pair of C-shaped Elements 530 which engage a Pivot Rod 540 upon which a Limiter 510 is disposed such that the maximum rotational motion is defined by these before it is restricted or locked by Limiter 510 which forms part of the Rotational Limiting Elements. As depicted in third Image 600C the Limiter 510 is depicted partially deployed for ease of depicting the C-shaped Elements 530.

Now referring to third and fourth Images 500C and 500D in FIG. 5 the Rotational Connector Limiter according to an embodiment of the invention is depicted with the Rotational Limiting Elements deployed such that rotational motion of the Front Bed Section 300A relative to the Rear Bed Section 300B is limited by the Limiter 510. As depicted in third Image 500C each Limiter 510 is also connected to a Spring 520, Retraction Element, which acts to move the Limiter 510 from the deployed to non-deployed position. Accordingly, the Limiter 510 must be actively deployed by the operator and/or control system to have an effect. Accordingly, the Limiters 510, as there is one per side of the Rear Bed Section 300B, must be deployed (activated) to limit rotational motion of the Rear Bed Section 300B relative to the Front Bed Section 300A.

However, within other embodiments of the invention the Retraction Element may be configured such that the Limiter 510 is deployed and must be actively retracted by the operator and/or control system. Accordingly, the Limiters 510, as there is one per side of the Rear Bed Section 300B, must be retracted (activated) in order to not limit rotational motion of the Rear Bed Section 300B relative to the Front Bed Section 300A.

First and second Images 600A and 600B depict views of the Rotational Connector Limiter during assembly - manufacture. In first Image 600A the Limiter 510 and Pivot Rod 540 are clearly visible. Within each of first to fourth Images 500A to 500D in FIG. 5 and first to third Images 600A to 600C in FIG. 6 a Deployment Means which moves the Limiter 510 under the action of the operator and/or control system is not depicted (for clarity) or visible within the assembled connection.

Within an embodiment of the invention the Deployment Means may have two positions, off and on, such that the Limiter 510 is either retracted fully allowing full range of motion or extended fully to limit motion to a reduced range or completely.

Within an embodiment of the invention the Deployment Means may have multiple set positions or be continuously set such that the Limiter 510 can be set to different defined ranges of motion between retracted fully allowing full range of motion or fully extended to limit motion to a reduced range or no motion.

Within an embodiment of the invention the Deployment Means may be a hydraulically driven mechanical actuator where the hydraulic system pressure or fluid volume adjust the stroke of the actuator and therein the position of the Limiter 510.

Within an embodiment of the invention the Deployment Means may be a fluidically driven mechanical actuator where the fluid system pressure or volume adjust the stroke of the actuator and therein the position of the Limiter 510.

Within an embodiment of the invention the Deployment Means may be an air operated brake where the air pressure or volume adjust the stroke of the actuator and therein the position of the Limiter 510.

Within an embodiment of the invention the Deployment Means may be an air operated brake chamber (also known as a service brake chamber) directly or indirectly connected to the air brake system of a vehicular element in the set of vehicular elements such that the Limiter 510 are extended upon actuation of the vehicles brakes. A Retraction Means may act to retract the Limiter 510 in conjunction with the air operated brake chamber such as a spring for example.

Within embodiments of the invention the Retraction Means may be multiple springs connected to the Limiter 510. Within other embodiments of the invention the Retraction Means may be a hydraulically driven mechanical actuator, a fluidically driven mechanical actuator, an air operated brake chamber or other suitable means as known in the art. Within an embodiment of the invention the spring may be a linear spring, such as depicted in third Image 500C in FIG. 5, a non-variable spring similarly attached as depicted in FIGS. 5 and 6. Alternatively, one or more torsion spring may be coupled to the Pivot Rod 540.

Within embodiments of the invention one or more sensors may be attached to one or more elements of the Rotational Connector Limiter and/or Retraction Means in order to provide data to the operator and/or control system. Such sensors may include, but not be limited to, a rotation sensor to detect the rotational position of the Limiter 510 forming part of the Rotational Connector Limiter, a strain gauge to measure the elongation - compression of a spring forming part of the Retraction Means, a positional sensor to define the position of an actuator engaging with the Limiter 510 (e.g. the yoke - shaft portion of an air operated break chamber, a strain gauge on the Limiter 510 or Pivot Rod 540 to determine engagement of the Rear Bed Section 300B with the Front Bed Section 300A.

Within embodiments of the invention a Connector between a Front Bed Section 102 and Rear Bed Section 103 such as depicted in FIGS. 2, 3, 4 and 5-6 may be demountably attached to the Front Bed Section 102 and Rear Bed Section 103. The Pivot Pin 600 may be demountably connected or permanently installed.

Within embodiments of the invention a Connector where the two portions are connected by a removable Pivot Pin 600 then the two portions of the Connector may be permanently attached to the Front Bed Section 102 and Rear Bed Section 103 respectively such that upon being brought into alignment the two portions of the Connector are connected by the Pivot Pin 600.

Whilst the preceding embodiments of the invention have been described with respect to a pair of In-Line Apertures 162 and 163 within Upper and Lower Cheek Plates 160 and 161 and Vertical In-Line Apertures 505 in Connector Link 500 in FIG. 2 or Front Bed Section 300A it would be evident that within other embodiments of the invention a single aperture in each portion linked via a Pivot Pin 600 is the minimum to provide the pivotal connection between the elmeents.

Whilst within the preceding description specific types of fitting, mounting, fixing and attachment means have been described and/or depicted it would be evident that these may be varied without departing from the scope of the invention.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
a first portion for attachment to a first vehicular element comprising a first aperture;
a second portion for attachment to a second vehicular element comprising a second aperture;
a limiter forming part of the first portion;
an actuator coupled to the limiter and the first portion; and
a pin; wherein
the pin upon insertion through the first aperture and the second aperture links and pivotally connects the first portion to the second portion.

2. The device according to claim 1, wherein
the first portion and second portion are pivotally connected to one another about a vertical axis after insertion of the pin through the first aperture and the second aperture;
the limiter is pivotally connected to the first portion and movable under action of an actuator from a first position to a second position; wherein
in the first position the first vehicular element and second vehicular element can rotate relative to one another; and
in the second position the first vehicular element and second vehicular element cannot rotate relative to one another.

3. The device according to claim 1, wherein
the first portion and second portion are pivotally connected to one another about a vertical axis after insertion of the pin through the first aperture and the second aperture;
the limiter is pivotally connected to the first portion and movable under action of an actuator between a first position to a second position; wherein
in the first position the first vehicular element and second vehicular element can rotate relative to one another;
in the second position the first vehicular element and second vehicular element cannot rotate relative to one another; and
a retention means is attached to the limiter and the first portion which acts to automatically return the limiter to the first position.

4. The device according to claim 1, wherein
the first portion and second portion are pivotally connected to one another about a vertical axis after insertion of the pin through the first aperture and the second aperture;
the limiter is pivotally connected to the first portion and movable under action of an actuator between a first position to a second position; wherein
in the first position the first vehicular element and second vehicular element can rotate relative to one another;
in the second position the first vehicular element and second vehicular element cannot rotate relative to one another; and
a retention means is attached to the limiter and the first portion which acts to automatically return the limiter to the second position.

5. The device according to claim 1, wherein
the first portion and second portion are pivotally connected to one another about a horizontal axis after insertion of the pin through the first aperture and the second aperture;
the limiter is pivotally connected to the first portion and movable under action of an actuator between a first position to a second position; wherein
in the first position the first vehicular element and second vehicular element can rotate relative to one another;
in the second position the first vehicular element and second vehicular element cannot rotate relative to one another.

6. The device according to claim 1, wherein
the first portion and second portion are pivotally connected to one another about a horizontal axis after insertion of the pin through the first aperture and the second aperture;
the limiter is pivotally connected to the first portion and movable under action of an actuator between a first position to a second position; wherein
in the first position the first vehicular element and second vehicular element can rotate relative to one another;
in the second position the first vehicular element and second vehicular element cannot rotate relative to one another; and
a retention means is attached to the limiter and the first portion which acts to automatically return the limiter to the first position.

7. The device according to claim 1, wherein
the first portion and second portion are pivotally connected to one another about a horizontal axis after insertion of the pin through the first aperture and the second aperture;
the limiter is pivotally connected to the first portion and movable under action of an actuator between a first position to a second position; wherein
in the first position the first vehicular element and second vehicular element can rotate relative to one another;
in the second position the first vehicular element and second vehicular element cannot rotate relative to one another; and
a retention means is attached to the limiter and the first portion which acts to automatically return the limiter to the second position.

8. The device according to claim 1, wherein
the first portion and second portion are pivotally connected to one another about a vertical axis after insertion of the pin through the first aperture and the second aperture;
the first portion comprises a first section for attachment to the first vehicular element and a second section comprising the first aperture;
the limiter is pivotally connected to the first portion and movable under action of an actuator from a first position to a second position; wherein
in the first position the first vehicular element and second vehicular element can rotate relative to one another;
in the second position the first vehicular element and second vehicular element cannot rotate relative to one another; and
the first section of the first portion and the second section of the first portion are pivotally connected to one another about a horizontal axis.
